(19) United States
(12) Patent Application Publication
(10) Pub. No.: US 2016/0044165 A1
(43) Pub. Date: Feb. 11, 2016

(54) ON-BOARD HANDLING OF CALLER IDENTIFICATION FOR WIRELESS TELEPHONY DEVICE

(71) Applicant: VONAGE NETWORK, LLC, HOLMDEL, NJ (US)

(72) Inventors: SAGI DUDAI, TEL AVIV (IL); MATTHEW KROKOSZ, WALL, NJ (US); GUY BARON, TEL AVIV (IL); BOAZ ZEHAVI, JERSEY CITY, NJ (US); GIL OSHER, TEL AVIV (IL); MARC P. LEFAR, HOLMDEL, NJ (US)

(21) Appl. No.: 14/456,820

(22) Filed: Aug. 11, 2014

(51) Int. Cl. H04M 3/42; G06F 3/0483

(52) U.S. Cl. CPC H04M 3/42068; G06F 3/0483

(57) ABSTRACT

A telephony device comprises a radio interface; a user interface section; a memory; and a processor. The radio interface is configured to receive a notification of an incoming call from a telephony network. The user interface section is configured to facilitate interaction with a user of the telephony device. The memory comprises a local contact book, the local contact book comprising a pairing of calling party telephone information and corresponding caller identification information. The processor is configured, upon receipt of the notification of the incoming call, to use the calling party telephone information to obtain paired caller identification information from the local contact book and to provide an indication of the paired caller identification information to the user interface section.

### TECHNICAL FIELD

The technology relates to telecommunications, and particular to telecommunications involving wireless telephony devices.

### BACKGROUND

A telephone subscriber generally has one or more telephony devices which are served by a home carrier and which are associated with a nominal telephone number, such as a directory number. Telephonic communications emanating or originating from a telephony device of the subscriber as a calling party (e.g., outgoing communications) are generally routed by the calling party's home carrier through one or more switches, and possibly networks of other carriers, to a called party. The called party may be a subscriber of the same or of another home carrier. Conversely, telephonic communications destined for the telephony device of the called telephone subscriber (e.g., incoming communications) are routed on the basis of, e.g., the nominal telephone number, through switches to the called party's home carrier so that the communications may be “terminated” at the called party, i.e., the telephone subscriber.

In some instances in which the telephony device is an analogue device, the communications involving the telephone subscriber may be initiated as analogue communications and thereafter may be adapted for packet transmission. In other cases the telephony device may be a data packet-compatible device, such as an Internet Protocol (IP) device, so that the communication is essentially entirely packet-based. In either case, Internet Protocol telephony systems have been provided to route various types of communications, at least in part, via data packets that are communicated over a data network. The data network is commonly the Internet. The types of communications may be, for example, telephone calls, video calls, text and video messages, and other forms of telephony and data communications.

In some instances an outgoing communication may be routed at the subscriber's request to the Internet Protocol telephony system, so that the communications may be completed or “terminated” by the Internet Protocol telephony system. Some users or subscribers of the IP telephony system may engage in communications using telephony devices that are connected by physical lines such as cables or wires to an access point such as an internet port. Such wired telephony devices may, thanks to the services of the IP telephony system, be moved from one physical location to another physical location, but at each such physical location are physically connected in wired manner to the respective access point.

Other users or subscribers of the IP telephony system may possess mobile or wireless telephony devices, such as a wireless terminal, user equipment (UE), mobile phone, smart phone, or laptop, tablet, or other device with mobile termination. Nowadays some telephony services including IP telephony systems provide computerized applications that may be downloaded to a mobile telephony device. Upon login to such mobile telephony applications (e.g., with user name and password) the mobile telephony device user may at least temporarily register the mobile telephony device with the Internet Protocol telephony system.

Many telephony services, upon alerting a called party of an incoming call, also provide calling party telephone information such as a calling party telephone number. But telephone numbers by themselves are not easily recognizable nor readily associated with the calling party in the mind of the called party. Accordingly, many telephony networks have provided a service in which the called party is also provided with caller identification information, e.g., “caller ID”. To provide such caller ID service, typically the telephony network maintains a server which includes a database that that stores caller identification information in association with calling party telephone information. When a call is routed to the called party, for called parties that subscribe to the caller ID service the telephony network provides both the calling party telephone information and the caller identification information as obtained from the network. The caller identification information is typically provided on a display so that it can be viewed by the called party.

Wireless telephony devices usually maintain a local contact book which the user of the telephony device may maintain by entering new contacts, telephone information for the new contacts, and some identification of the new contacts. The user of such a wireless telephony device may upload its local contact book to a network server, e.g., to a server of a telephony system. Upon first time registration of the network application with the network, there may be an initial synchronization of the contact book with the server, and thereafter any update of the local contact book may require re-synchronization with the version of the contact book maintained by the network server. When the network directs a call to the telephony device, the call is routed from the network to the telephony device by direct signaling (such as a Session Initiation Protocol [SIP] Invite) or by a push notification.

Push notifications enable a client application resident on a telephony device to notify a user of new messages or events even when the user is not actively using the client application. That is, a push notification allows a client application to notify the user of new messages or events without the need to actually open the client application. Push notifications are facilitated by a push notification service, which typically is a third party service that is generally not directly connected with a telephony service provider. A push notification service provides a channel through which a push notification may be sent from an application on a server to the client application on the telephony device. Example push notification services are Apple® Push Notification Service [APNs] on Apple® telephony devices and Goggle® Cloud Messaging [GCM] on Google®/Android™ telephony devices. If a notification for a client software application arrives when that client application is not running on the telephony device, the APNS and GSM services allow the telephony device to alert the user that the client application has data waiting for it. In other words, when new data for a client application arrives, a notification is sent through the channel to the APNS or GCM service, which pushes the notification to the target telephony device. Push notifications may be used for various purposes, such as reaching a communications software application installed on a telephony device in a situation in which an IP telephony system may otherwise have difficulty, as described, e.g., in U.S. patent application Ser. No. 13/940,647, filed Jul. 12, 2013, entitled “Method and Apparatus for VoIP Communication Completion to a Mobile Device”, and U.S. patent application Ser. No. 13/940,804, filed Jul. 12, 2013, entitled “Method and Apparatus for VoIP Communication Completion to a Mobile Device”, both of which are incorporated herein by reference in their entirety.

Before sending such signaling or push notification the network may resolve or translate the phone number (or any other caller information) of the calling party to a caller identifier using the version of the contact list maintained at the network server, and include the network-deduced caller identifier in the signaling or push notification provided to the called party.

Using network server facilities for providing caller identification information has several disadvantages. For example, complexity of the network server infrastructure and operation is increased, since there must be scalability to accommodate synchronization of the constantly changing information in the various network-stored contact books of the various subscribers. The changing contacts records maintained both by the wireless telephony device and telephony network must be initially and thereafter periodically synchronized. Any out-of-synchronization condition between the telephony network and telephony device may result in failure to display the caller identification information at the telephony device upon receipt of an incoming call. Thus, from a network server perspective it is difficult to support multi-device contact management by relying on network-stored contact books.

### SUMMARY

In one of its aspects the technology disclosed herein concerns a telephony device. The telephony device comprises a radio interface; a user interface section; a memory; and a processor. The radio interface is configured to receive a notification of an incoming call from a telephony network. The user interface section is configured to facilitate interaction with a user of the telephony device. The memory comprises a local contact book, the local contact book comprising a pairing of calling party telephone information and corresponding caller identification information. The processor is configured, upon receipt of the notification of the incoming call, to use the calling party telephone information to obtain paired caller identification information from the local contact book and to provide an indication of the paired caller identification information to the user interface section.

In an embodiment and mode the processor is configured, upon receipt of the notification of the incoming call, to invoke a non-native application associated with the telephony network. The telephony network is a non-native telephony network for the telephony device. The non-native application comprises instructions stored on non-transient computer readable medium which, when executed, use the calling party telephone information to obtain the paired caller identification information from the local contact book and to provide the indication of the paired caller identification information to the user interface section.

In an exemplary embodiment and mode the notification of the incoming call comprises a routing of the call to the telephony device by direct signaling.

In an exemplary embodiment and mode the notification of the incoming call comprises a routing of the call to the telephony device by a push notification. In an exemplary implementation the notification of the incoming call comprises a routing of the call to the telephony device by a private push notification.

In an example embodiment and mode the processor is configured, upon receipt of notification of the incoming call, to forward the calling party telephone information from an operating system of the telephony device to a telephony network application executable by the processor but associated with the telephony network. The telephony network application when executed is configured to obtain the paired caller identification information from the local contact book and to use the operating system to provide the indication of the paired caller identification information to the user interface section.

In an example embodiment and mode the processor is further configured upon receipt of the notification of the incoming call, to include the caller identification information of the incoming call obtained from the local contact book on a missed call list as being a missed call; and to remove the incoming call from the missed call list when the incoming call is accepted by the user of the telephony device.

In an example embodiment and mode the processor is further configured upon receipt of the notification of the incoming call, to use the calling party telephone information to obtain paired caller identification information from a subset of the local contact book.

In another of its aspects the technology disclosed herein concerns a method of operating a telephony device. The method comprises receiving a notification of an incoming call from a telephony network and, upon receipt of the incoming call, obtaining caller identification information from a local contact book stored in a non-transient memory of the telephony device by using calling party telephone information associated with the incoming call. The local contact book comprises a pairing of the calling party telephone information and the corresponding caller identification information. The method further comprises providing an indication of the paired caller identification information from the local contact book for output to a user of the telephony device.

In an exemplary embodiment and mode the method further comprises, upon receipt of the notification of the incoming call, invoking a non-native application associated with the telephony network. The telephony network is a non-native telephony network for the telephony device. The non-native application comprises instructions stored on non-transient computer readable medium which, when executed, use the calling party telephone information to obtain the paired caller identification information from the local contact book and to provide the indication of the paired caller identification information.

In an exemplary embodiment and mode receiving the notification of the incoming call comprises receiving a routing of the call to the telephony device by direct signaling.

In an exemplary embodiment and mode receiving the notification of the incoming call comprises receiving a routing of the call to the telephony device by a push notification. further comprising receiving a routing of the call to the telephony device by a private push notification.

In an exemplary embodiment and mode the method further comprises the telephony device not using any caller identification information maintained by the telephony network when providing an indication of caller identification information to the user of the telephony device.

In an exemplary embodiment and mode the method further comprises a processor of the telephony device, upon receiving the notification of the incoming call, forwarding the calling party telephone information from an operating system of the telephony device to a telephony network application executable by the processor but associated with the telephony network. The telephony network application, when executed: obtains the paired caller identification information from the local contact book; and uses the operating system to provide the indication of the paired caller identification information to the user interface section.

In an exemplary embodiment and mode the method further comprises, upon receipt of the notification of the incoming call, including the caller identification information of the incoming call obtained from the local contact book on a missed call list as being a missed call; and, removing the incoming call from the missed call list when the incoming call is accepted by the user of the telephony device.

In an exemplary embodiment and mode the method further comprises, upon receipt of the notification of the incoming all, using the calling party telephone information to obtain paired caller identification information from a subset of the local contact book.

In another of its aspects the technology disclosed herein concerns a computer program product comprising instructions stored on a non-transient memory which, when executed by a processor of a telephony device, result in performance of the various acts. The acts include upon receipt of an notification of the incoming call from a telephony network, obtaining caller identification information from a local contact book stored in a non-transient memory of the telephony device by using calling party telephone information associated with the incoming call. The local contact book comprises a pairing of the calling party telephone information and the caller identification information. The acts further include providing an indication of the paired caller identification information from the local contact book for output to a user of the telephony device.

In an example embodiment and mode the computer program product comprising instructions stored on the non-transient memory which, when executed by the processor of the telephony device, result in performance of the following further acts: (1) upon receipt of the notification of the incoming call, including the caller identification information of the incoming call obtained from the local contact book on a missed call list as being a missed call; and (2) removing the incoming call from the missed call list when the incoming call is accepted by the user of the telephony device.

In an example embodiment and mode the computer program product comprises instructions stored on the non-transient memory which, when executed by the processor of the telephony device, upon receipt of the notification of the incoming call, invoke a non-native application associated with the telephony network. The telephony network is a non-native telephony network for the telephony device. The non-native application uses the calling party telephone information to obtain the paired caller identification information from the local contact book and to provide the indication of the paired caller identification information.

In an example embodiment and mode receiving the notification of the incoming call comprises receiving a routing of the call to the telephony device by direct signaling.

In an example embodiment and mode receiving the notification of the incoming call comprises receiving a routing of the call to the telephony device by a push notification.

In an example embodiment and mode receiving the notification of the incoming call comprises receiving a routing of the call to the telephony device by a private push notification.

In another of its aspects the technology disclosed herein concerns a telephony device comprising a radio interface; a memory; and a processor. The radio interface is configured to receive a notification of an incoming call from a telephony network. The memory comprises a local contact book, the local contact book comprising a pairing of calling party telephone information and corresponding caller identification information. The processor is configured, upon receipt of the notification of the incoming call: (1) to use the calling party telephone information to obtain the paired caller identification information from the local contact book; (2) upon receipt of the notification of the incoming call; (3) to include the caller identification information of the incoming call obtained from the local contact book on a missed call list as being a missed call; and (4) to remove the incoming call from the missed call list when the incoming call is accepted by the user of the telephony device.

In an example embodiment and mode the processor is further configured upon receipt of the notification of the incoming call, to use the calling party telephone information to obtain paired caller identification information from a subset of the local contact book.

In an example embodiment and mode the telephony device further comprises a user interface section, and wherein the processor is further configured to provide an indication of the caller identification information of the incoming call as received from the local contact book as a missed call on the user interface section.

In an example embodiment and mode the notification of the incoming call comprises a routing of the call to the telephony device by direct signaling or by a push notification.

In an example embodiment and mode the processor is configured not to use any caller identification information maintained by the telephony network when providing an indication of caller identification information to the user of the telephony device.

In an example embodiment and mode the processor is configured, upon receipt of notification of the incoming call, to forward the calling party telephone information from an operating system of the telephony device to a telephony network application executable by the processor but associated with the telephony network; and the telephony network application when executed is configured to obtain the paired caller identification information from the local contact book and to use the operating system to provide the indication of the paired caller identification information to the user interface section.

In another of its aspects the technology disclosed herein concerns a method in a telephony device. In an example embodiment and mode the method comprises receiving a notification of an incoming call from a telephony network; upon receipt of the notification of the incoming call, to include the caller identification information of the incoming call obtained from the local contact book on a missed call list as being a missed call; and to remove the incoming call from the missed call list when the incoming call is accepted by the user of the telephony device.

In an example embodiment and mode the processor is further configured upon receipt of the notification of the incoming call, to use the calling party telephone information to obtain paired caller identification information from a subset of the local contact book.

In an example embodiment and mode the telephony device further comprises a user interface section, and the processor is further configured to provide an indication of the caller identification information of the incoming call as received from the local contact book as a missed call on the user interface section.

In an example embodiment and mode the notification of the incoming call comprises a routing of the call to the telephony device by direct signaling or by a push notification.

In an example embodiment and mode the processor is configured not to use any caller identification information maintained by the telephony network when providing an indication of caller identification information to the user of the telephony device.

In an example embodiment and mode the processor is configured, upon receipt of notification of the incoming call, to forward the calling party telephone information from an operating system of the telephony device to a telephony network application executable by the processor but associated with the telephony network; and the telephony network application when executed is configured to obtain the paired caller identification information from the local contact book and to use the operating system to provide the indication of the paired caller identification information to the user interface section.

In another of its aspects the technology disclosed herein concerns a method in a telephony device. The method comprises receiving a notification of an incoming call from a telephony network and, upon receipt of the notification of the incoming call, using a calling party telephone information for the incoming call to obtain the paired caller identification information from a local contact book. The local contact book comprises a pairing of calling party telephone information and corresponding caller identification information. The method further comprises, upon receipt of the notification of the incoming call, including the caller identification information of the incoming call obtained from the local contact book on a missed call list as being a missed call; and thereafter removing the incoming call from the missed call list when the incoming call is accepted by the user of the telephony device.

In an example embodiment and mode the method further comprises, upon receipt of the notification of the incoming call, using use the calling party telephone information to obtain paired caller identification information from a subset of the local contact book.

In an example embodiment and mode the method further comprises providing an indication of the caller identification information of the incoming call as received from the local contact book as a missed call.

In an example embodiment and mode the notification of the incoming call comprises a routing of the call to the telephony device by direct signaling or by a push notification.

In an example embodiment and mode the method further comprises not using any caller identification information maintained by the telephony network when providing an indication of caller identification information to the user of the telephony device.

In an example embodiment and mode the method further comprises, upon receipt of notification of the incoming call, forwarding the calling party telephone information from an operating system of the telephony device to a telephony network application executable by the processor but associated with the telephony network. A telephony network application obtains the paired caller identification information from the local contact book and using the operating system to provide the indication of the paired caller identification information to the user interface section.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of an exemplary communications environment, including various elements which are associated with an Internet protocol (IP) telephony system, which service a telephony device operating within coverage of the Internet protocol (IP) telephony system in accordance with an exemplary embodiment and mode.

FIG. 2 is a schematic view illustrating example functionalities and or units comprising a non-limiting exemplary embodiment of a telephony device having on-board caller identification processing according to an exemplary embodiment.

FIG. 3 is a flowchart illustrating basic exemplary acts or steps performed by a on-board caller identification processor of a telephony device according to an exemplary embodiment and mode.

FIG. 4 is a schematic view illustrating example functionalities and or units comprising a non-limiting exemplary, more detailed embodiment of a telephony device according to FIG. 2, and further depicting various acts performed thereby.

FIG. 5 is a schematic view illustrating example functionalities and or units comprising a non-limiting exemplary embodiment of a telephony device according to another exemplary embodiment that includes on-board missed call list handling.

FIG. 6 is a flowchart illustrating basic exemplary acts or steps performed by telephony device of FIG. 5 according to an exemplary embodiment and mode.

FIG. 7 is a schematic view illustrating example functionalities and or units comprising a non-limiting exemplary, more detailed embodiment of a telephony device according to FIG. 5, and further depicting various acts performed thereby.

FIG. 8 is a schematic view illustrating example functionalities and or units comprising the telephony device according to FIG. 2, and showing that a search of a local contact book database may be preferentially performed.

FIG. 9 is a schematic view showing an example of machine hardware comprising one or more processors for implementing aspects of a wireless telephony device according to exemplary embodiments.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

In the following description, the terms “VoIP system,” “VoIP telephony system,” “IP system” and “IP telephony system” are all intended to refer to a system that connects callers and that delivers data, text and video communications using Internet Protocol data communications.

The following description will refer to “telephony communications.” The term “telephony communications” is intended to encompass any type of communication that could pass back and forth between users of an IP telephony system. This includes audio and video telephone, text messages, video messages and any other form of telephony or data communication.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an Apple iPhone™, a RIM Blackberry or a comparable device running Google's Android operating system could be a mobile telephony device.

In still other instances, a mobile telephony device may be a device that is not traditionally used as a telephony device, but which includes a wireless data transceiver that can establish a wireless data connection to a data network. Examples of such devices include the Apple iPod Touch™ and the iPad™. Such a device may act as a mobile telephony device once it is configured with appropriate application software.

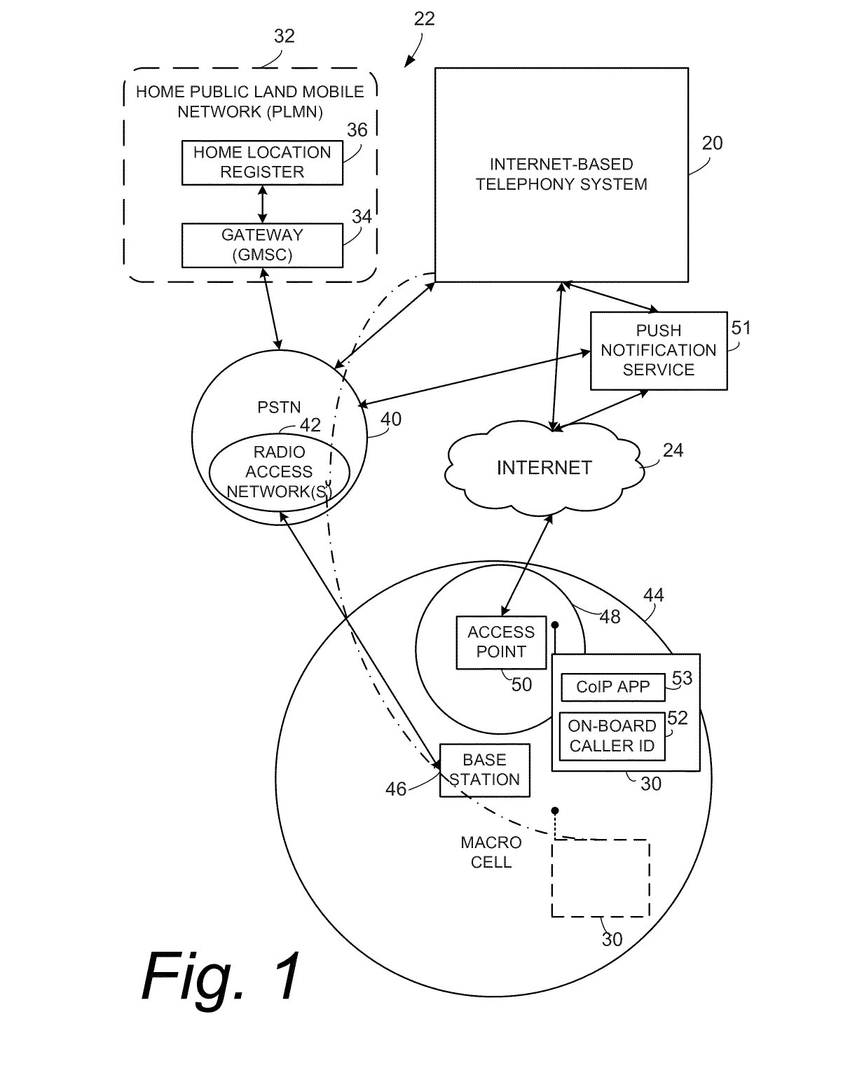

FIG. 1 shows a telephony system 20, in context of an exemplary generic communications system 22. In view of the fact that the telephony system 20 may be an Internet (IP) telephony system, the telephony system 20 is shown as connected to a data communications network such as Internet 24. A telephony device 30, which for sake of illustration happens to be a mobile or wireless telephony device such as a user equipment unit, smart phone, or laptop with mobile termination, for example, is associated with a customer of the telephony system 20.

The customer is not only a customer of telephony system 20, but is also served by the customer's home public land mobile network (PLMN) 32. The customer's home public land mobile network 32 is shown in FIG. 1 as comprising a PLMN gateway or switching center (GMSC) 34, as well as a PLMN home location register (HLR) 36. In this respect, the customer's home public land mobile network (PLMN) 32 or another telephone system may be considered as a “native” or “first” telephony system for the customer, while the telephony system 20 may be considered a “non-native” or “second” telephony system for the customer. In this regard, see, e.g., U.S. Pat. No. 8,265,083, incorporated herein by reference.

Both home public land mobile network 32 and telephony system 20 are connected to the public switched telephone network (PSTN) 40. The public switched telephone network (PSTN) 40 may comprise one or more radio access network(s) (RANs) 42. The home public land mobile network 32 is connected to public switched telephone network (PSTN) 40 through the PLMN gateway 34. Telephony system 20 is also connected to public switched telephone network (PSTN) 40 through its gateway(s), described hereinafter.

FIG. 1 further shows telephony device 30 as being situated in a radio access network cell 44 which is served by base station 46 of a radio access network 42. The base station 46 may be a base station controller (BSC), NodeB, eNodeB, or other type of base station. As such, the network cell 44 may be referred to as a macro cell and the base station 46 as a macro base station. Typically macro base stations such as macro base station 46 communicate with wireless terminals using licensed frequencies.

It will be appreciated that some macro base stations belong to networks which have data connection handling capability while other base stations belong to networks that do not have data connection handling capability. The former networks provide services such as call service and short message service (SMS), and typically include base stations which report to a radio network controller node and which may belong to a roaming area. The former networks additionally provide General Packet Radio Service (GPRS)/3G/LTE services and typically include base stations characterized as NodeB or eNodeB and for which routing areas are defined. The base stations of both types of networks broadcast their roaming and routing area.

FIG. 1 also shows telephony device 30 as being within a smaller cell 48 (e.g., a micro cell, home cell, pico cell, or femto cell) which is served by a wireless access point 50 of an internet-connected wireless access service. The access point 50 may provide Wi-Fi or WiMAX access to telephony device 30. Wi-Fi is a technology that allows an electronic device to exchange data or connect to the Internet wirelessly using microwaves in the 2.4 GHz and 5 GHz bands, and thus includes any “wireless local area network (WLAN) products that are based on the Institute of Electrical and Electronics Engineers' (IEEE) 802.11 standards”. The smaller cell 48 may also be referred to as an access point cell. Typically access points such as access point 50 communicate with wireless terminals using unlicensed frequencies. Thus, in the FIG. 1 situation, the telephony device 30 has a data connection through wireless access point 50 to the internet telephony service 20.

FIG. 1 also shows by broken lines that the telephony device 30 may roam away from access point 50 and therefore is no longer with in WiFi or WiMax coverage. After roaming away from WiFi or WiMax coverage the data connections of telephony device 30 may be handled by base station 46 if base station 46 is configured to handle data connections, e.g., is a Node-B or eNodeB type base station which has a data connection such as GPRS/3G/LTE. As such, being within coverage of Node-B base station 46 the roaming telephony device 30 is able to make a data connection through the licensed frequencies of the base station 46 over the air interface, through appropriate core network nodes such as Serving GPRS Support Node (SGSN) 47 and GPRS Gateway Support Node (GGSN) 49 to internet 24, and through internet 24 to telephony system 20. Thus, although not using the WiFi or unlicensed frequencies, as shown by the dotted-dashed line in FIG. 1 the roamed telephony device 30 still has access through the data services of the macro cell to telephony system 20, and thus remains “in coverage”.

As also shown in FIG. 1, communications system 22 may also comprise a push notification service or push notification server 51. The push notification service 51 is shown as being coupled to the Internet 24, which allows the push notification service 51 to send push notifications to the mobile telephony device 30. The push notifications could be sent to the mobile telephony device 30 via the Internet 24, or via a path that includes the Internet 24 and the a cellular data network (e.g., radio access networks 42). In alternate embodiments, the push notification service 51 may communicate directly with the cellular network (e.g., radio access networks 42) in order to cause push notifications to be delivered to mobile telephony device 30.

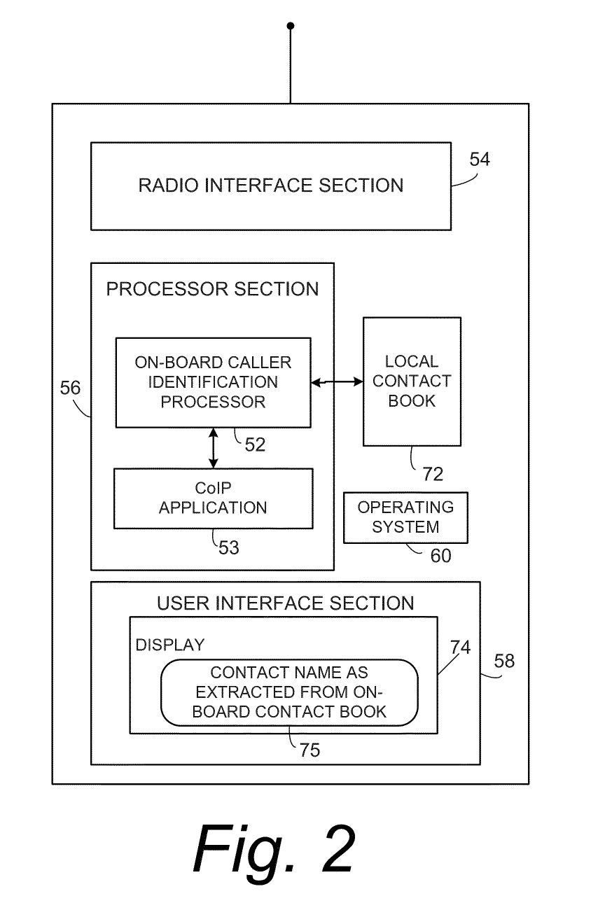

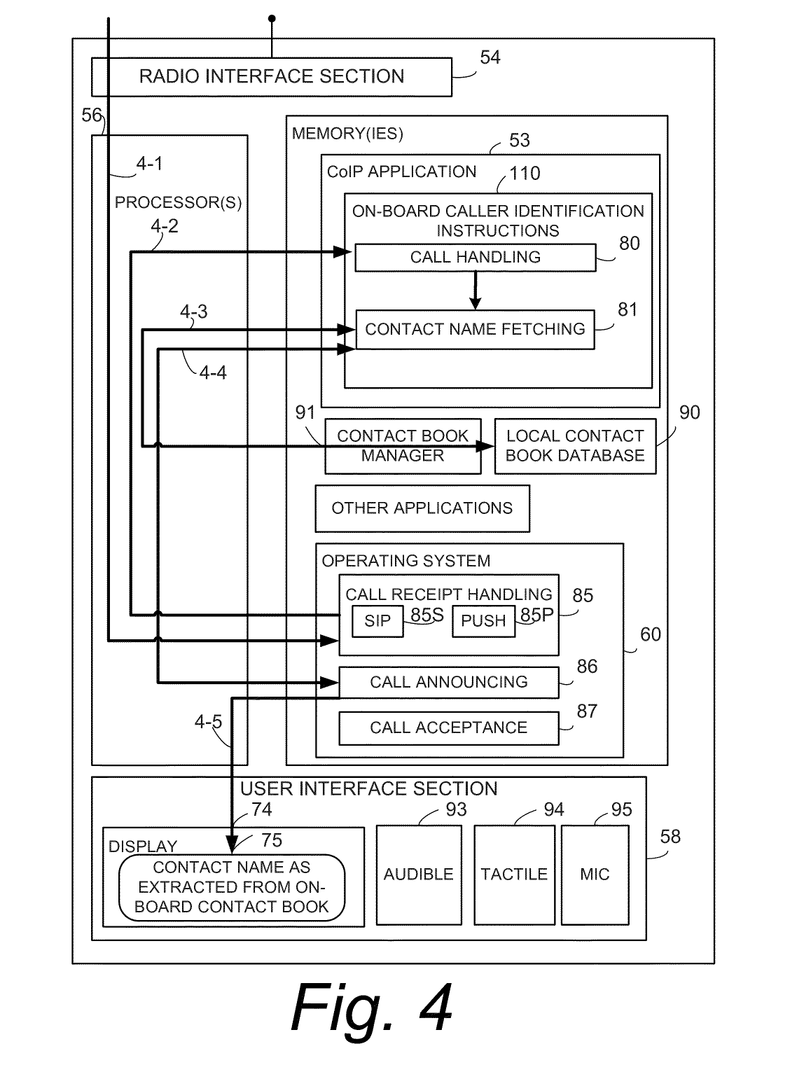

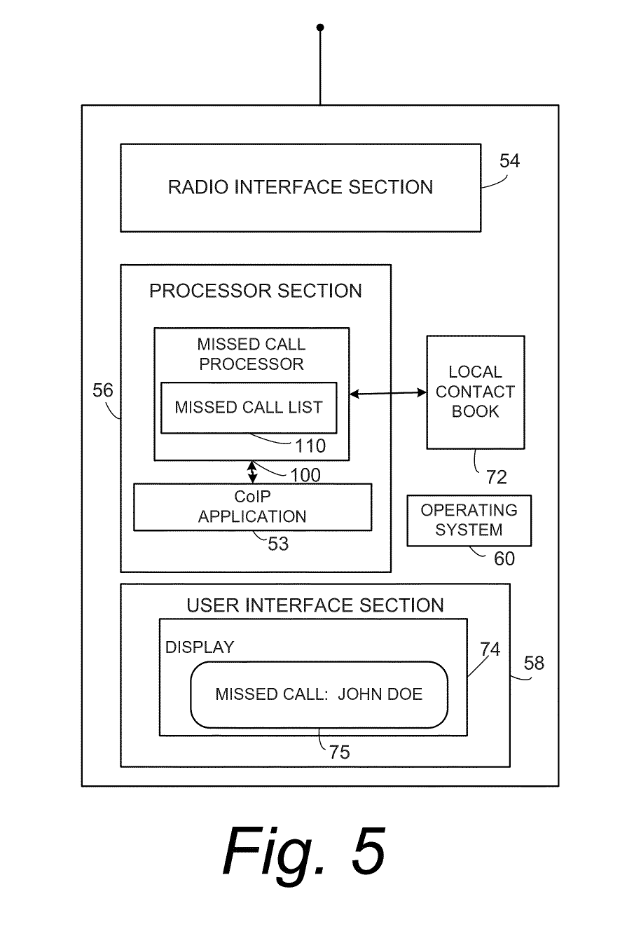

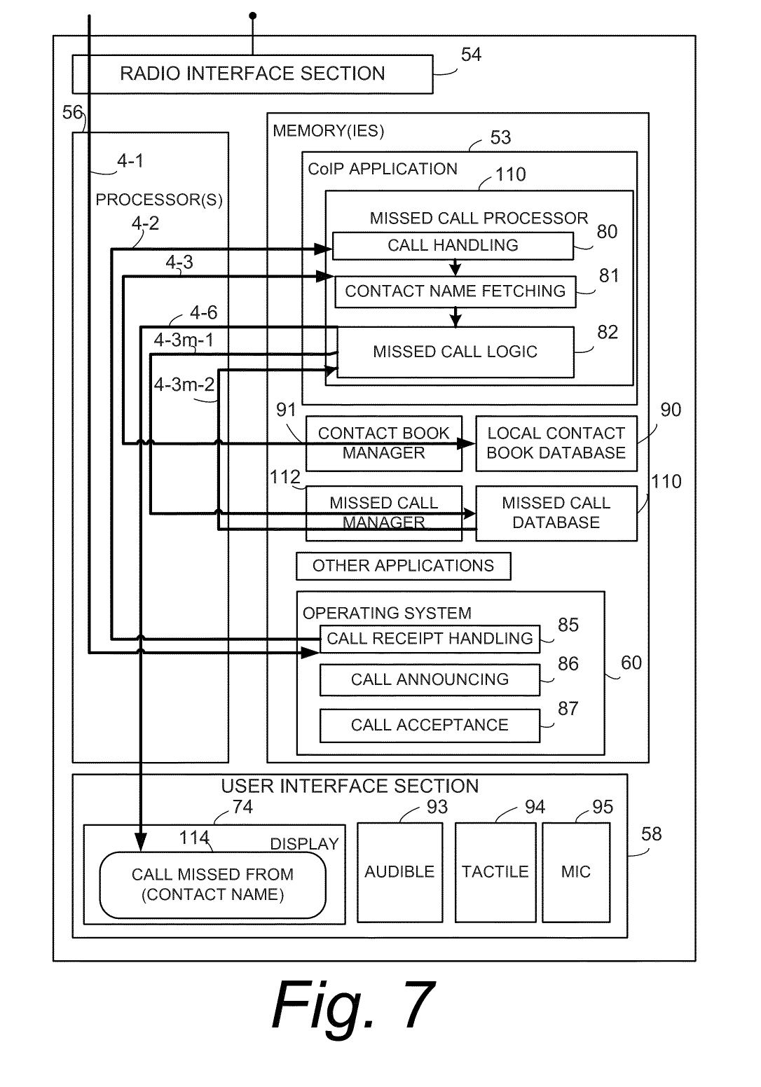

The telephony device 30 of FIG. 1 provides on-board caller identification processing. In an example embodiment and mode on-board caller identification processing is facilitated by on-board caller identification processor 52. In an example implementation the on-board caller identification processor 52 may work in conjunction with, e.g., execute instructions of, a client software application herein known as “CoIP application” 53, as described hereinafter. In view of the fact that the CoIP application 53 may be provided by or in conjunction with the telephony service 20, the CoIP application 53 is characterized as an “over the top” (“OTT”) or non-native executable application. FIG. 2 shows an example generic telephony device 30 having on-board caller identification processor 52; FIG. 4 shows a more detailed example implementation of the telephony device of FIG. 2. FIG. 5 shows an example alternative embodiment of telephony device 30 having a missed call processor; FIG. 7 shows a more detailed example implementation of the telephony device of FIG. 5.

FIG. 2 thus shows a generic exemplary embodiment of telephony device 30 that provides on-board caller identification processing. As shown in FIG. 2, telephony device 30 comprises radio frequency section 54, also known as a radio frequency interface, for enabling the telephony device 30 to communicate over radio frequencies, e.g., over an air or radio interface, with an appropriate communication node. As understood from FIG. 1, in some situations the communication node may be the wireless access point 50 through which the telephony device 30 participates in WiFi or WiMax type data communications, as a link in overall data communications with the IP telephony service 20. In other situations also understood from FIG. 1 the communication node may be a macro base station 46 through which the telephony device 30 participates in GPRS-type communications, as a link in overall data communications with the IP telephony service 20. The person skilled in the art will understand that radio frequency section 54 therefore includes appropriate transmitter(s) and receiver(s), as well as antenna(s), as well as radio frequency processing circuitry for pre-processing or post-processing of signals applied to or received from such transmitter(s) and receiver(s).

The telephony device 30 also comprises processor section 56 and user interface section 58. The user interface section 58 may comprise one or more different types of interface devices, and includes interface devices that are configured to facilitate interaction with a user. Among the interface devices that may comprise user interface section 58 are a display/touch screen, a keyboard, one or more switches or buttons, a microphone, and a speaker.

The processor section 56 may comprise one or more processor(s) or controller(s) as elaborated herein and discussed further with respect to FIG. 9. The processor section 56 executes various sets of instructions stored on non-transient computer-readable media. One of the sets of instructions comprises an operating system 60 for telephony device 30. Other of the sets of instructions may comprise software programs, at least some of which are in the form of computerized applications (“apps”). One such application may be an application provided by or designed to work in conjunction with communications with a telephony network, such as internet-based telephony system 20, and thus may generically be termed a “network application” installed on the telephony device. In view of the fact that the communications encompassed by the technology described herein are not limited to voice communications, the internet-based telephony system 20 may also be referred to as a “Communication over IP”, or “CoIP system”, and its network application executed by processor section 56 of telephony device 30 may be referred to as the aforementioned “CoIP application” 53. As such, “CoIP” comprises but it not limited to VoIP communications.

As described herein, the CoIP application 53 includes functionality in the form of coded, executable instructions that enable telephony device 30 to perform an on-board caller identification function. Since such functionality/instructions are executed by processor section 56, the telephony device 30 is said to comprise the on-board caller identification processor 52. The on-board caller identification processor 52 works in conjunction with an on-board local contact book 72 that is stored in non-transient memory and is managed and maintained by aspects of telephony device 30 outside of CoIP application 53.

The local contact book 72 preferably comprises plural entries, each entry comprising at least a pairing of calling party telephone information and caller identification information. The calling party telephone information may comprise, for example, a calling party telephone number. The caller identification information typically comprises information by which the user of the telephony device 30 can recognize a name (caller name) or other moniker of the calling party more readily than the calling party telephone information (in many instances the calling party telephone information may not be recognized or understood at all). While some of the entries of local contact book 72 may be downloaded from the telephony network, preferably at least some of information in the local contact book 72 is entered into the memory by the user via the user interface section 58.

As indicated previously, a wireless device such as telephony device 30 may upload its local contact book to a network server, e.g., to a server of internet-based telephony system 20. Upon first time registration of the network application with the network, there may be an initial synchronization of the contact book with the server, and thereafter any update of the local contact book may require re-synchronization with the version of the contact book maintained by the network server. When the network directs a call to the telephony device 30, the call is routed from the network to the telephony device 30 by direct signaling (such as a Session Initiation Protocol [SIP] Invite) or by a push notification (e.g., APNS on Apple or GCM on Google). Before sending such signaling or push notification the network may resolve or translate the phone number (or any other caller information) of the calling party to a caller identifier using the version of the contact list maintained at the network server, and include the network-deduced caller identifier in the signaling or push notification provided to the called party.

Before describing further the operation of on-board caller identification processor 52, use and implementation of push notification service 51 is described in basic terms. In general, a push notification service 51 allows an application such as CoIP application 53 that is installed on a telephony device 30 to complete a registration process that results in CoIP application 53 receiving a device token. The device token uniquely identifies the telephony device 30. The CoIP application 53 on the telephony device 30 then provides this token to the service provider that created the application (e.g., telephony system 20) on the telephony device 30. Once the telephony system 20 has possession of the token associated with the telephony device 30, the telephony system 20 can cause the push notification service 51 to send push notifications to the telephony device 30. A request for a push notification that is sent from the telephony system 20 to the push notification service 51 would include the device token, and information about the type of push notification that is to be sent to the telephony device 30. When the push notification service 51 receives a push notification request from telephony system 20, push notification service 51 uses the information in the request to create a formatted push notification that it then delivers to telephony device 30. The push notification can cause the telephony device 30 to take several different actions. For example, a push notification can cause telephony device 30 to update a number displayed on a badge associated with CoIP application 53. The number usually indicates that new information is available to CoIP application 53, and the number may indicate the quantity of the new information. When a user sees a number on an application badge, the user can press the badge to load and run the application (e.g., CoIP application 53), which usually results in the CoIP application 53 requesting and obtaining the new information that is waiting. A push notification can also cause a notification message to be displayed on telephony device 30. The notification message will usually include two buttons that the user can press. One button, usually labeled as “DISMISS,” allows the user to dismiss the notification message. If the user presses this button, the notification message will no longer be displayed, and no further action will be taken by the mobile device. However, if the user pushes the other button, which is usually labeled as “VIEW,” telephony device 30 will normally load and run the application (e.g., CoIP application 53) on telephony device 30. See, e.g., U.S. Pat. application Ser. No. 13/940,647, filed Jul. 12, 2013, entitled “Method and Apparatus for VoIP Communication Completion to a Mobile Device”, and U.S. patent application Ser. No. 13/940,804, filed Jul. 12, 2013, entitled “Method and Apparatus for VoIP Communication Completion to a Mobile Device”, both of which are incorporated herein by reference in their entirety.

Having described push notifications generally, it should be mentioned that even though a SIP INVITE can be used to receive in an inbound call on some versions of operating system 60, there are still situations where that exist where a SIP INVITE can not be used. Such situations include, for example, when the CoIP application 53 is terminated by user or operating system 60. In those cases, a push notification may be used to alert the inbound call. As described further herein, in some versions of the operation system 60 these push notifications cannot execute background code to do the lookup, e.g., to obtain the paired caller identification information from the local contact book 72. The silent push on other versions of the operating system 60 address this limitation which is relevant to this claim.

The on-board caller identification processor 52 eliminates or renders unnecessary involvement of the telephony network in providing caller identification in the process of the telephony device 30 receiving an incoming call. As explained herein, the on-board caller identification processor 52 consults the local contact book 72 and (without any post-call reception signaling interaction with the network) provides (in user interface section 58) an indication of the on-board caller identification information as obtained from local contact book 72. In other words, the on-board caller identification processor 52 is configured, upon receipt of the notification of the incoming call, to use the calling party telephone information to obtain the paired caller identification information from the local contact book and to provide an indication of the paired caller identification information to the user via the user interface section.

The indication of the on-board caller identification information may be provided in various ways, including visual or audible. FIG. 2 shows an exemplary embodiment in which user interface section 58 comprises a display device 74, and further illustrates a screen or message 75 which provides caller identification information in the form of a contact name as extracted from the local contact book 72.

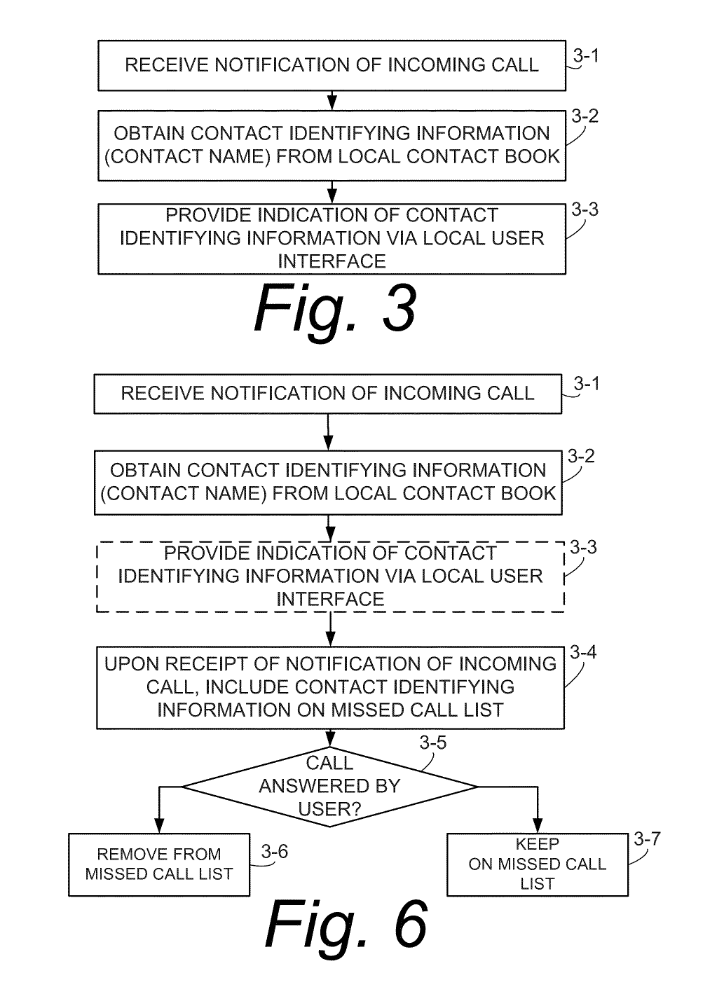

FIG. 3 illustrates example acts or steps that comprise an example method of operating the telephony device 30 in accordance with the technology disclosed herein. Act 3-1 comprises the telephony device 30 receiving a notification of an incoming call from a telephony network. As mentioned above, the notification may be using SIP INVITE signaling or a push notification. Upon receipt of the notification of the incoming call, act 3-2 comprises the on-board caller identification processor 52 obtaining caller identification information from local contact book 72 (stored in a non-transient memory of the telephony device) by using calling party telephone information associated with the incoming call. For example, the on-board caller identification processor 52 uses the calling party telephone information as an index or key to locate or fetch the caller identification information paired therewith in local contact book 72. Act 3-3 comprises the on-board caller identification processor 52 providing an indication of the paired caller identification information from the local contact book 72 for output (e.g., in user interface section 58) to a user of the telephony device, e.g., via a local user interface of telephony device 30.

FIG. 4 shows an example embodiment of telephony device 30 in more detail. In addition to radio frequency section 54, processor section 56, and user interface section 58, FIG. 4 shows memory section 76. The memory section 76 may comprise one or more different types of non-transient memories, including random access memory (RAM) and read only memory (ROM). As mentioned above, memory section 76 may have stored therein instructions, in the form of programs or system, which are executed by processor section 56. In other words, the programs or systems stored in memory section 76 are, at appropriate times, loaded into instruction registers or the like of processor section 56 and are executed by processor section 56. For example, the operating system 60 is also stored in memory section 76 and executed by processor section 56.

The CoIP application 53 is also executed by processor section 56. The CoIP application 53 may take the form of a computer software product comprising instructions stored on a non-transient memory which, when executed by processor section 56 of telephony device 30, result in performance of the acts herein described (see, e.g., the acts of FIG. 3).

FIG. 4 shows the CoIP application 53 as including instructions which, when executed by processor section 56, implement the on-board caller identification processor 52. Although the on-board caller identification processor 52 is not shown in FIG. 4, it is understood, e.g., with reference to FIG. 1 and FIG. 2, to be implemented by processor section 56. The CoIP application 53 is shown in FIG. 4 as comprising call handling unit 80 and contact name fetching unit 81.

Although operating system 60 comprises many aspects, only those pertinent to the technology disclosed herein are specifically discussed herein. In this regard, FIG. 4 shows an example embodiment of operating system (OS) 60 as comprising OS call receipt handling unit 85, OS call announcing unit 86, and OS call acceptance logic 87. The OS call receipt handling unit 85 comprises both a SIP call handling subunit 85S and a push notification call handling subunit 85P. The SIP call handling subunit 85S handles an inbound call received through carrier signaling to telephony device 30; push notification call handling subunit 85P handles an inbound call received through a push notification (e.g., from push notification service 51).

The memory section 76 also includes other routines and functions, as well as databases or information storage area. For example, memory section 76 includes local contact book database 90 and its contact book manager 91. The local contact book database 90 stores the local contact book 72 with its pairing of calling party telephone information and caller identification information for plural entries. The contents of local contact book database 90 may be configured, inquired, and extracted using contact book manager 91. In other words, input and output operations, as well as search operations, for local contact book database 90 are performed by contact book manager 91.

FIG. 4 also shows various operations, including the basic acts of FIG. 3, performed by the various units of the more detailed embodiment of telephony device 30. It is again noted that, although FIG. 4 generally shows processor section 56, it should be remembered that processor system 56 includes on-board caller identification processor 52 (see FIG. 2), and at times these terms are used interchangeably since the processor section 56 may implement the on-board caller identification processor 52.

Act 4-1 of FIG. 4 shows a notification of an incoming call being routed to telephony device 30 from a telephony network, such as internet-based telephony system 20. As indicated above, the incoming call may be routed from a server of the telephony network either by direct signaling (e.g., SIP INVITE) or by a push notification. Both the SIP INVITE and push payloads include calling party telephone information, e.g., a caller telephone number. However, in the case of direct signaling (e.g., the SIP INVITE) the operating system 60 of telephony device 30 receives the inbound call through carrier signaling as opposed to a push notification from push notification server 51. Moreover, as explained above, on some versions of operating system 60 there are situations where in which a SIP INVITE can not be used. Such situations include, for example, when the CoIP application 53 is terminated by user or operating system 60. In those cases, a push notification may be used to alert the inbound call.

In the context of the technology disclosed herein, push notifications pertaining to caller identification are directed by the operating system 60 to the CoIP application 53, an over-the-top (OTT) application executed by processor section 56. A push notification server, when providing a push notification of an incoming call, may provide a telephone number of the calling party. Optionally, the push notification server may attempt to determine a caller identifier for the calling party. However, determining the call identifier involves extra processing effort and time, and requires further signaling overhead thereby increasing signaling congestion. Moreover, the information consulted by the notification server when attempting to obtain caller identifier information may be outdated.

In general push notifications may be classified as public or private. A private push notification generally provides some form of alert to the user upon arrival of the push notification, e.g., a banner or notification message that may require further interaction from the user before the application to which the push notification is directed is given central processing (CPU) time. A second type of push notification is a private notification, in which the user is not provided with an alert but instead the push notification is essentially transparently (to the user) and automatically (without user intervention or approval or input) directed by the operating system to the particular application to which the push notification pertains. The Apple iOS7 operating system is an example of an operating system that facilitates private push notifications.

The notification of the incoming call (depicted by act 4-1) is handled by the operating system 60, and particularly by OS call receipt handling unit 85. As act 4-2 the operating system 60 forwards the notification of the incoming call, e.g., the push notification or the direct signaling, to on-board caller identification processor 52, and particularly to call handling unit 80. In other words, the processor section 56 is configured, upon receipt of notification of the incoming call, to forward the calling party telephone information from operating system 60 to CoIP application 53. As understood from the foregoing, the CoIP application 53 is executable by processor section 56 but is associated with (e.g., provided by or configured to work in conjunction with) the internet-based telephony system 20. Thus, the processor section 56, upon receipt of the notification of the incoming call, invokes (e.g., calls or activates) a non-native application (OTT application) associated with the telephony network (e.g., CoIP application 53). In this regard, it was mentioned previously that telephony network 20 is a non-native telephony network for the telephony device. The non-native application (e.g., CoIP application 53) comprises instructions stored on non-transient computer readable medium which, when executed, use the calling party telephone information to obtain the paired caller identification information from the local contact book, and further to provide the indication of the paired caller identification information to the user interface section.

As act 4-3 the processor section 56 (e.g., on-board caller identification processor 52) executes instructions included in CoIP application 53 (an the OTT application) to lookup and obtain the caller identification information in the local contact book 72. In particular, the contact name fetching unit 81 sends the calling party telephone information obtained from the incoming direct signaling or push notification to contact book manager 91 and obtains from local contact book database 90 the caller identification information paired with the calling party telephone information. Then, knowing the caller identification information which is paired with the calling party telephone information, as act 4-5 the processor section 56 functioning as the on-board caller identification processor 52 uses the OS call announcing unit 86 of operating system 60 to provide the caller identification information (e.g., the contact name) to the user of telephony device 30 at or about the time of ringing or alerting the user of the incoming call. Thus, CoIP application 53, when executed, is configured to obtain the paired caller identification information from the local contact book 72 and to use the operating system 60 to provide the indication of the paired caller identification information to the user interface section 58.

An indication of the caller identification information may be provided to one or more of the devices comprising user interface section 58. FIG. 4 so happens to show the caller identification information as being provided to display device, whereon is depicted the notification screen 75 as hereinbefore described. The indication of the caller identification information may be provided in various displayed forms, such as (for example) a notification banner (e.g., a banner on part of a screen) or as a full screen display (e.g., on an incoming call screen). The particular display manner may be related to or depend on the nature of operating system 60. For example, on an Android type operating system the indication may be provided as a full screen, while on an Apple operating system (iOS) a local push notification may be invoked that would generate a customized notification banner.

The indication of the caller identification information may also be provided to other output devices, such as audible output device 93 (speaker). Other user interface devices comprising user interface section 58 may comprise tactile output device (e.g., haptic device) 94 and microphone 95.

Thus, in an exemplary embodiment and mode, the processor section 56 of telephony device 30 when implementing the on-board caller identification processor 52 does not use any caller identification information maintained by the telephony network in order to provide an indication of caller identification information to the user of the telephony device.

In whatever form or device the indication of caller identification information is provided, such indication is the only aspect of execution of on-board caller identification processor 52 that is discernible (e.g., visible) to the end user of telephony device 30, as all preceding acts and steps are internal and are essentially “pre-call” processing.

The on-board caller identification processor 52 as described herein may be implemented within existing and previous Android™ Operation System (e.g., Google®) devices. On such Android™ systems the CoIP application 53 with its on-board caller identification processor 52 can both run in the background and also get to run custom application code (e.g., “get CPU”) upon receiving a push notification (e.g., via Google Cloud Messenger [GCM]).

For Apple® operation system devices (iOS), on the other hand, implementation of the on-board caller identification processor 52 may be OS version dependent. In versions in which on-board caller identification processor 52 runs in the background the on-board caller identification processor 52 receives the inbound call notification via SIP INVITE and gets the needed CPU to run instructions for the acts as described herein. Some versions of the Apple operation system such as the iOS7 Apple operating system provide the aforementioned “private” or “silent” push feature. Those operating systems can get CPU upon arrival of a “silent” or “private” push and thereby run instructions for the acts as described herein. Such operation system versions differ from previous versions that allowed only “public push” having content that was visible immediately to the end user without the application getting any CPU to be able to customize the notification beforehand.

The apparatus and methods of the technology disclosed herein which use the local contact book to lookup or otherwise obtain paired caller identification information has numerous advantages. For example, the telephony device 30 is not dependent upon a possibly outdated contact list maintained externally, e.g., maintained by a telephone service provider or other server. Nor is there the need to maintain synchronization between the local contact book and an external counterpart for caller identification purposes. In the case of incoming call notification being provided by a push notification service, the push notification server does not have to perform the additional task of determining the caller identification information. Eliminating such task reduces the signaling and, not only between the call notification server and an external contact list, but also by reducing the payload of the push notification since the caller identification information now not need be included. Moreover, such elimination may increase speed of delivery of the incoming call. Yet further, in the case of private push notifications, the user is automatically provided with a single and timely indication of the caller identifier associated with the incoming call.

FIG. 5 illustrates an exemplary embodiment and mode wherein CoIP application 53 includes missed call processor 100. The missed call processor 100 may comprise or work in conjunction with the on-board caller identification processor 52 of the example embodiment of FIG. 2. Acts performed by the missed call processor 100 include those illustrated in FIG. 6. The acts of FIG. 6 generally include the act 3-1 through 3-3 of FIG. 3, with act 3-3 (providing the indication of caller identification information to the user interface section 58) being desirable but optional. The additional acts of FIG. 6 comprise act 3-4 and act 3-5. Act 3-4 comprises storing, upon receipt of then notification of the incoming call, an indication that the call is missed. Storing an indication that the call is missed may comprise storing the caller identification information for the call (obtained by act 3-2) on a missed call list 110. Act 3-4 may be performed in parallel, e.g., essentially simultaneously, with optional act 3-3 (providing the indication of caller identification information to the user). Act 3-4 is thus in some sense premature and its stored indication may be considered as tentative, since the user has not yet had opportunity to respond or answer the call.

Act 3-5 comprises determining whether the incoming call is, in fact, actually answered or responded to by the user. If the user responds to (e.g., “picks up” or otherwise accepts) the call, the call may be considered as “answered” and (as act 3-6) the call removed from the missed call list 110. If there is no answer or response to the incoming call after a predetermined period of time, the incoming call is considered as “missed” and the caller identification information for the incoming call remains on the missed call list 110 (as indicated by act 3-7).

FIG. 7 resembles FIG. 4, but shows more details of structure and operation of CoIP application 53 concerning the example embodiment which includes missed call processor 100. The missed call processor 100 may be implemented by processor section 56. The FIG. 7 shows the CoIP application 53 as comprising not only the call handling unit 80 and contact name fetching unit 81, but also missed call logic 82. FIG. 7 also shows inclusion of missed call list 110, in the form of a missed call database, as well as missed call manager 112 which performs input and output operations with respect to missed call list 110.

FIG. 7 further shows by act 4-3m-1 that, upon reception of the notification of the incoming call, the processor section 56, when implementing the missed call processor 100 and particularly when executing missed call logic 82 (e.g., in parallel with act 4-3), posts or lists (in accordance with act 3-4) the caller identification information of the incoming call on the missed call list 110. In other words, upon receipt of the notification of the incoming call, the incoming call is marked on missed call list 110 as being missed. The incoming call may be listed by caller identification information and optionally additionally by calling party telephone information, and may include other information such as time of receipt of the incoming call.

Only if the user of telephony device 30 picks up or otherwise affirmatively responds (e.g., accepts) the call does the missed call logic 82 change the status of the incoming call, e.g., deletes or removes the caller identification information of the incoming call from missed call list 110 (as indicated by act 4-3m-2) or otherwise unmarks the incoming call as being answered or accepted. The missed call processor 100 may be apprised of call acceptance upon notification by OS call acceptance logic 87 of operating system 60.

When a call is missed, as act 4-6 missed call logic 82 of CoIP application 53 may prompt one or more of the devices of user interface section 58 to provide an indication that the call is missed. Such an indication is depicted by screen 114 shown as output on display device 74, e.g., a brief textual statement that a call was missed from a certain contact whose caller identification information is displayed in screen 114. The screen may provide not only the caller identification information for the missed call, but also the time of the incoming missed call.

In an example embodiment the missed call list 110 may actually be a received call list wherein the caller identification information of the “missed” calls are specially flagged or otherwise marked as missed or unanswered. In such example embodiment, the storing of an indication that the call is missed accordingly to act 3-4 of FIG. 6 may comprise marking or flagging the caller identification information of the incoming call in a call received list. Conversely, removing the indication (act 3-6) may comprise removing or unsetting the flag or marker associated with the caller identification information of the received call.

It should be understood that the acts of FIG. 7 may be performed in conjunction with other acts of FIG. 4, including those performed by on-board caller identification processor 52, even though such other acts may not be specifically illustrated in FIG. 7. Moreover, notification of the incoming call for FIG. 7 may be provided either by direct signaling (e.g., SIP INVITE) or by push notification (e.g., either public or private, as previously discussed).

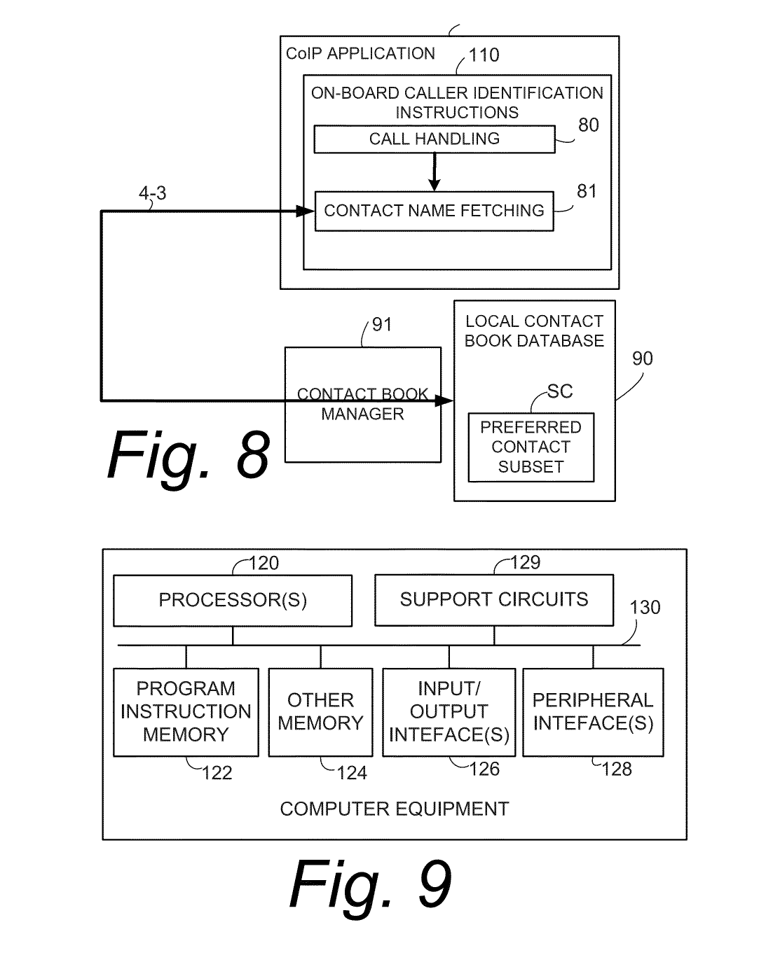

FIG. 8 shows that act 4-3 of FIG. 4 or FIG. 7, involving a search of local contact book database 90, may be preferentially performed. That is, the telephony device 30 may comprise an optimizing logic or processor (one or both of contact name fetching unit 81 and/or contact book manager 91) seek to optimize the caller identification lookup operation. For example, instead of scanning all the contacts in the local contact book database 91, the optimizing logic may first scan only a “preferred sub set” of the numbers (for example: recent calls), as indicated by contact subset CS of local contact book database 90. The preferred contact subset CS may have unproportional matching. For example, although the local contact book database 90 may have 2000 entries/people, the optimizing logic or processor initially searches only the preferred contact subset CS of, for example, ten to twenty number in a case in which ninety percent of incoming calls are from the contact subset CS of ten to twenty calls. Of course, the number or constituency of the preferred contact subset CS may change from embodiment to embodiment and depending on the nature and extent of contacts of the particular user involved.

Functions described herein, including the CoIP application 53 of wireless telephony device 30 may, at least in some embodiments and modes, be performed by machine hardware. FIG. 9 shows an example of such machine hardware as comprising one or more processors 120 (which may be or comprise processor section 56 of telephony device 30), program instruction memory 122; other memory 124 (e.g., RAM, cache, etc.); input/output interfaces 126; peripheral interfaces 128; support circuits 129; and busses 130 for communication between the aforementioned units.

The memory 124, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 129 are coupled to the processors 120 for supporting the processor in a conventional manner These circuits include cache, power supplies, clock circuits, input/output circuitry and subsystems, and the like.

Software routines such as software for CoIP application 53 (including on-board caller identification processor 52 and missed call processor 100) of wireless telephony device 30 may be computer program products which include coded instructions stored on non-transient medium and which are executed by processors 120/56 of wireless telephony device 30 for performing the acts described herein. For the machine hardware of wireless telephony device 30 such software/computer program products may be stored on non-transient memory such as program instruction memory 122. Also, the software routines could also be stored remotely from the CPU, e.g., remotely from processors 120/56. For example, the software could be resident on servers and memory devices that are located remotely from the CPU, but which are accessible to the CPU via a data network connection. Such software, when executed by processors 120, transforms the general purpose computer into a specific purpose computer that performs one or more functions of telephony device 30. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the exemplary hardware recited above.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A telephony device comprising:
a radio interface configured to receive a notification of an incoming call from a telephony network;
a user interface section configured to facilitate interaction with a user of the telephony device;
a memory comprising a local contact book, the local contact book comprising a pairing of calling party telephone information and corresponding caller identification information;
a processor configured, upon receipt of the notification of the incoming call, to use the calling party telephone information to obtain paired caller identification information from the local contact book and to provide an indication of the paired caller identification information to the user interface section.

2. The telephony device of claim 1, wherein the processor is configured, upon receipt of the notification of the incoming call, to invoke a non-native application associated with the telephony network, the telephony network being a non-native telephony network for the telephony device, and wherein the non-native application comprises instructions stored on non-transient computer readable medium which, when executed, use the calling party telephone information to obtain the paired caller identification information from the local contact book and to provide the indication of the paired caller identification information to the user interface section.

3. The telephony device of claim 1, wherein the notification of the incoming call comprises a routing of the call to the telephony device by direct signaling.

4. The telephony device of claim 1, wherein the notification of the incoming call comprises a routing of the call to the telephony device by a push notification.

5. The telephony device of claim 4, wherein the notification of the incoming call comprises a routing of the call to the telephony device by a private push notification.

6. The telephony device of claim 1, wherein the processor is configured not to use any caller identification information maintained by the telephony network when providing an indication of caller identification information to the user of the telephony device.

7. The telephony device of claim 1, wherein
the processor is configured, upon receipt of notification of the incoming call, to forward the calling party telephone information from an operating system of the telephony device to a telephony network application executable by the processor but associated with the telephony network; and
the telephony network application when executed is configured to obtain the paired caller identification information from the local contact book and to use the operating system to provide the indication of the paired caller identification information to the user interface section.

8. The telephony device of claim 1, wherein the processor is further configured:
upon receipt of the notification of the incoming call, to include the caller identification information of the incoming call obtained from the local contact book on a missed call list as being a missed call; and
to remove the incoming call from the missed call list when the incoming call is accepted by the user of the telephony device.

9. The telephony device of claim 1, wherein the processor is further configured upon receipt of the notification of the incoming call, to use the calling party telephone information to obtain paired caller identification information from a subset of the local contact book.

10. A method of operating a telephony device comprising:
receiving a notification of an incoming call from a telephony network;
upon receipt of the incoming call, obtaining caller identification information from a local contact book stored in a non-transient memory of the telephony device by using calling party telephone information associated with the incoming call, the local contact book comprising a pairing of the calling party telephone information and the corresponding caller identification information;
providing an indication of the paired caller identification information from the local contact book for output to a user of the telephony device.

11. The method of claim 10, further comprising, upon receipt of the notification of the incoming call, invoking a non-native application associated with the telephony network, the telephony network being a non-native telephony network for the telephony device, and wherein the non-native application comprises instructions stored on non-transient computer readable medium which, when executed, use the calling party telephone information to obtain the paired caller identification information from the local contact book and to provide the indication of the paired caller identification information.

12. The method of claim 10, wherein receiving the notification of the incoming call comprises receiving a routing of the call to the telephony device by direct signaling.

13. The method of claim 10, wherein receiving the notification of the incoming call comprises receiving a routing of the call to the telephony device by a push notification.

14. The method of claim 13, further comprising receiving a routing of the call to the telephony device by a private push notification.

15. The method of claim 10, further comprising the telephony device not using any caller identification information maintained by the telephony network when providing an indication of caller identification information to the user of the telephony device.

16. The method of claim 10, further comprising:
a processor of the telephony device, upon receiving the notification of the incoming call, forwards the calling party telephone information from an operating system of the telephony device to a telephony network application executable by the processor but associated with the telephony network; and
the telephony network application, when executed:
obtaining the paired caller identification information from the local contact book; and
using the operating system to provide the indication of the paired caller identification information to the user interface section.

17. The method of claim 10, further comprising:
upon receipt of the notification of the incoming call, to include the caller identification information of the incoming call obtained from the local contact book on a missed call list as being a missed call;
to remove the incoming call from the missed call list when the incoming call is accepted by the user of the telephony device.

18. The method of claim 10, further comprising upon receipt of the notification of the incoming all, using the calling party telephone information to obtain paired caller identification information from a subset of the local contact book.

19. A computer program product comprising instructions stored on a non-transient memory which, when executed by a processor of a telephony device, result in performance of the following acts:
upon receipt of an notification of the incoming call from a telephony network, obtaining caller identification information from a local contact book stored in a non-transient memory of the telephony device by using calling party telephone information associated with the incoming call, the local contact book comprising a pairing of the calling party telephone information and the caller identification information;
providing an indication of the paired caller identification information from the local contact book for output to a user of the telephony device.

20. The computer program product of claim 19, comprising instructions stored on the non-transient memory which, when executed by the processor of the telephony device, upon receipt of the notification of the incoming call, invoke a non-native application associated with the telephony network, the telephony network being a non-native telephony network for the telephony device, and wherein the non-native application uses the calling party telephone information to obtain the paired caller identification information from the local contact book and to provide the indication of the paired caller identification information.

21. The computer program product of claim 19, comprising instructions stored on the non-transient memory which, when executed by the processor of the telephony device, result in performance of the following further acts:
upon receipt of the notification of the incoming call, including the caller identification information of the incoming call obtained from the local contact book on a missed call list as being a missed call;
removing the incoming call from the missed call list when the incoming call is accepted by the user of the telephony device.

22. The computer program product of claim 19, wherein receiving the notification of the incoming call comprises receiving a routing of the call to the telephony device by direct signaling.

23. The computer program product of claim 19, wherein receiving the notification of the incoming call comprises receiving a routing of the call to the telephony device by a push notification.

24. The computer program product of claim 19, wherein receiving the notification of the incoming call comprises receiving a routing of the call to the telephony device by a private push notification.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)
